(19) United States
(12) Patent Application Publication
(10) Pub. No.: US 2018/0222286 A1
(43) Pub. Date: Aug. 9, 2018

(54) METHOD TO HEAT THE CABIN WHILE COOLING THE BATTERY DURING FAST CHARGE

(71) Applicant: Ford Global Technologies, LLC, Dearborn, MI (US)

(72) Inventors: Timothy Noah BLATCHLEY, Dearborn, MI (US); James George GEBBIE, Rochester Hills, MI (US); Angel Fernando PORRAS, Dearborn, MI (US)

(21) Appl. No.: 15/428,310

(22) Filed: Feb. 9, 2017

(51) Int. Cl. B60H 1/03; B60H 1/00; B60H 1/32; H01M 10/63; H01M 10/663

(52) U.S. Cl. CPC B60H 1/03; B60H 1/00278; H01M 10/663; B60H 1/3205; H01M 10/63; B60H 1/00885

(57) ABSTRACT

A thermal management system of a vehicle is disclosed. The vehicle includes a battery-coolant system including a chiller defining a thermal capacity and an electronic expansion valve arranged to selectively route fluid to the cooler. The system includes a heater-core system including an outside heat exchanger and a heating expansion valve arranged to selectively route fluid to the outside heat exchanger. The vehicle also includes a controller that is configured to, in response to a battery charge rate exceeding a threshold, open the battery expansion valve, and in response to the battery chiller having an insufficient capacity to achieve a temperature threshold as defined by a heater core thermometer, open the heating expansion valve.

### TECHNICAL FIELD

The present disclosure relates to a control strategy and method for operating an automotive vehicle heating system while charging the vehicle battery.

### BACKGROUND

The need to reduce fuel consumption and emissions in automobiles and other vehicles is well known. Vehicles are being developed that reduce or completely eliminate reliance on internal-combustion engines. Electric and hybrid vehicles are one type of vehicle currently being developed for this purpose. Electric and hybrid vehicles include a traction motor that is powered by a traction battery. Traction batteries require a thermal-management system to thermally regulate the temperature of the battery cells.

### SUMMARY

According to one aspect of this disclosure, a thermal management system of a vehicle is disclosed. The vehicle includes a battery-coolant system including a chiller defining a thermal capacity and an electronic expansion valve arranged to selectively route fluid to the cooler. The system includes a heater-core system including an outside heat exchanger and a heating expansion valve arranged to selectively route fluid to the outside heat exchanger. The vehicle includes a controller that is configured to, in response to a battery charge rate exceeding a threshold, opening the battery expansion valve, and the battery chiller having an insufficient capacity to achieve a temperature threshold as defined by a heater core thermometer, opening the HEVX.

According to another aspect of this disclosure, a vehicle system is disclosed. The system includes an ambient valve arranged to route fluid to an ambient heat exchanger, a battery valve arranged to route fluid to a battery, and a controller configured to, in response to a battery heat rate exceeding a threshold, opening the battery valve, and a chiller in fluid communication with the heat exchanger and battery having a temperature differential indicative of an insufficient capacity to heat a vehicle cabin and open the ambient valve.

According to yet another aspect of this disclosure, a method of controlling a vehicle climate system is disclosed. The method includes opening an electronic expansion valve associated with a battery chiller in response to receiving requests for battery fast charge and cabin heating. The method also includes opening an expansion valve associated with an outside heat exchanger to heat a vehicle cabin in response to a chiller capacity being insufficient to achieve a temperature threshold as defined by a heater core temperature sensor.

### BRIEF DESCRIPTION OF THE DRAWINGS

FIG. 1 is a schematic diagram of an example hybrid vehicle.

FIG. 2 is a schematic diagram of an example vehicle climate control system.

FIG. 3 is a flow chart of an algorithm according to one embodiment of this disclosure.

FIG. 4 is a flow chart of an algorithm according to another embodiment of this disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Electric and hybrid vehicles include a traction motor that is powered by a traction battery. As batteries of these vehicles are being charged they can generate a substantial amount of heat. This is particularly true when the vehicle is undergoing a “fast charge.” Traction batteries require a thermal-management system to thermally regulate the temperature of the battery cells. Some electric and hybrid vehicles use a high-voltage heater to provide heat to the vehicle cabin. It is advantageous to limit the amount of required electricity to power a high-voltage heater within the vehicle. One way to decrease the amount of electricity required is to capture heat from the air that surrounds the vehicle as well as heat that is generated by the battery while charging.

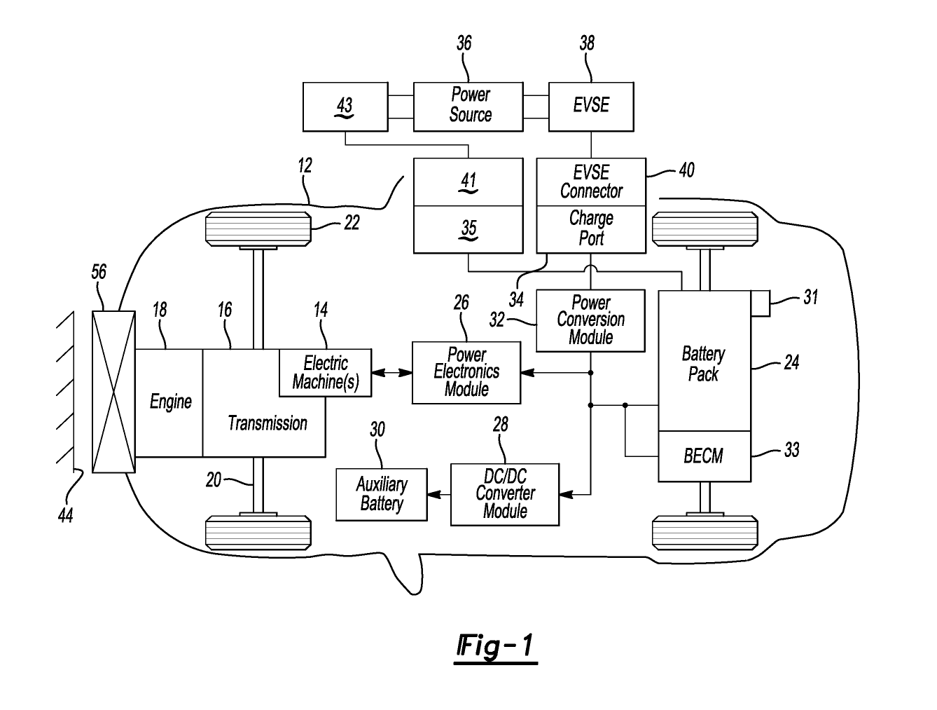

Referring to FIG. 1, a schematic of an example plug-in hybrid vehicle is illustrated. The vehicle 12 includes an electric machine 14 mechanically connected to a transmission 16. The electric machines 14 may operate as a motor or a generator. If the vehicle is a hybrid-electric vehicle, the transmission 16 is mechanically connected to an engine 18. The transmission 16 is mechanically connected to the wheels 22 via a driveshaft 20. The electric machine 14 can provide propulsion and deceleration capability. The electric machines 14 also act as generators and can provide fuel economy benefits by recovering energy through regenerative braking.

A traction battery or battery 24 stores energy that can be used by the electric machines 14. The traction battery 24 typically provides a high-voltage direct current (DC) output from one or more battery cell arrays, sometimes referred to as battery cell stacks, within the traction battery 24. The battery cell arrays include one or more battery cells.

The battery cells (such as a prismatic, pouch, cylindrical, or any other type of cell), convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle.

Different battery pack configurations are available to address individual vehicle variables including packaging constraints and power requirements. The battery cells may be thermally regulated with a thermal management system. Examples of thermal management systems include air-cooling systems, liquid-cooling systems, and a combination of air and liquid systems.

The traction battery 24 is electrically connected to one or more power electronics modules 26 through one or more contactors (not shown). The one or more contactors isolate the traction battery 24 from other components when opened, and connect the traction battery 24 to other components when closed. The power-electronics module 26 may be electrically connected to the electric machines 14 and may provide the ability to bi-directionally transfer electrical energy between the traction battery 24 and the electric machines 14.

In addition to providing energy for propulsion, the traction battery 24 may provide energy for other vehicle electrical systems. A typical system may include a DC/DC converter 28 that converts the high-voltage DC output of the traction battery 24 to a low-voltage DC supply that is compatible with other vehicle components. Other high-voltage loads, such as air-conditioning compressors and electric heaters, may be connected directly to the high-voltage supply without the use of a DC/DC converter module 28. In a typical vehicle, the low-voltage systems are electrically connected to the DC/DC converter and an auxiliary battery 30 (e.g., a 12 volt battery).

A battery energy control module (BECM) 33 is shown in communication with the traction battery 24. The BECM 33 may act as a controller for the traction battery 24 and may also include an electronic monitoring system that manages temperature and state of charge for each of the battery cells. The traction battery 24 may have a temperature sensor 31 such as a thermistor or other temperature gauge. The temperature sensor 31 may be in communication with the BECM 33 to provide temperature data regarding the traction battery 24. The BECM 33 may be part of a larger vehicle-control system that includes one or more additional controllers.

The vehicle 12 may be recharged by an external power source 36. The external power source 36 may be a connection to an electrical outlet connected to the power grid or may be a local power source (e.g., solar power). The external power source 36 is electrically connected to a vehicle charger 38. The charger 38 may provide circuitry and controls to regulate and manage the transfer of electrical energy between the power source 36 and the vehicle 12. The external power source 36 may provide DC or AC power to the charger 38. The charger 38 may have a charge connector 40 for plugging into a charge port 34 of the vehicle 12. The charge port 34 may be any type of port configured to transfer power from the charger 38 to the vehicle 12. The charge port 34 may be electrically connected to a charger or on-board power-conversion module 32. The power-conversion module 32 may condition the power supplied from the charger 38 to provide the proper voltage and current levels to the traction battery 24. The power-conversion module 32 may interface with the charger 38 to coordinate the delivery of power to the vehicle 12. The charger connector 40 may have pins that mate with corresponding recesses of the charge port 34. In other embodiments, the charging station may be an induction charging station.

The vehicle 12 may have equipment configured for a fast charging mode. For example, the vehicle 12 may have fast-charge port 40 that is connectable with a fast-charge connector 40.

In one embodiment, charging station 36, also referred to as an external power source 36, provides relatively high amperage current to traction battery 24 during the fast-recharging process. For instance, charging station 36 is a “DC Fast Charge” charging station using high voltage (e.g., 400-500V) and high current (e.g., 100-300 A) to charge battery 24. Using the DC Fast Charge, the battery 24 can be charged relatively quickly. In other embodiments, charging station 36 may provide high amperage current or relatively low amperage current.

Because of the higher current, more heat is produced during the higher-voltage charging modes. In some of the charging modes, such as fast charge, the battery 24 may be actively cooled to prevent overheating. The temperature of battery 24 should be maintained within a given range while the battery is operating, such as during discharge and charge. The temperature range depends on the type and properties of the battery 24. In particular, the temperature of battery 24 should not exceed a maximum operating temperature.

The temperature of the battery 24 depends on ambient temperature and the rate of discharge or charge in conjunction with the cooling architecture described above. The following observations can be made with all else being equal. The temperature of battery 24 will be higher with a high ambient temperature (e.g., a hot summer day) than with a low ambient temperature (i.e., a cold winter night). The temperature of battery 24 will be higher when the battery is discharged faster during heavy driving conditions and thereby generates more heat than compared to light driving conditions. The heating rate of the battery 24 will be higher when the battery is charged by high current, which heats the battery quickly, than when the battery is charged with lower current.

The various components discussed may have one or more controllers to control and monitor the operation of the components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers.

The traction battery 24, the passenger cabin, and other vehicle components are thermally regulated with one or more thermal-management systems. An outside heat exchanger 56 is shown in front of the engine 18. The outside heat exchanger 56 may sometimes be referred to as an ambient heat exchanger 56, that facilitates heat transfer from surrounding air to fluid flowing through the exchanger. An active grill shutter 44 is disposed forward of the outside heat exchanger 56. The active grill shutter includes a number of vanes that may be actuated from an open to a closed position and vice versa. When open, the vanes allow a flow of air from the outside of the vehicle to the outside heat exchanger 56. When closed, the vanes disrupt this flow of air and prevent a majority of the air from reaching the outside heat exchanger 56.

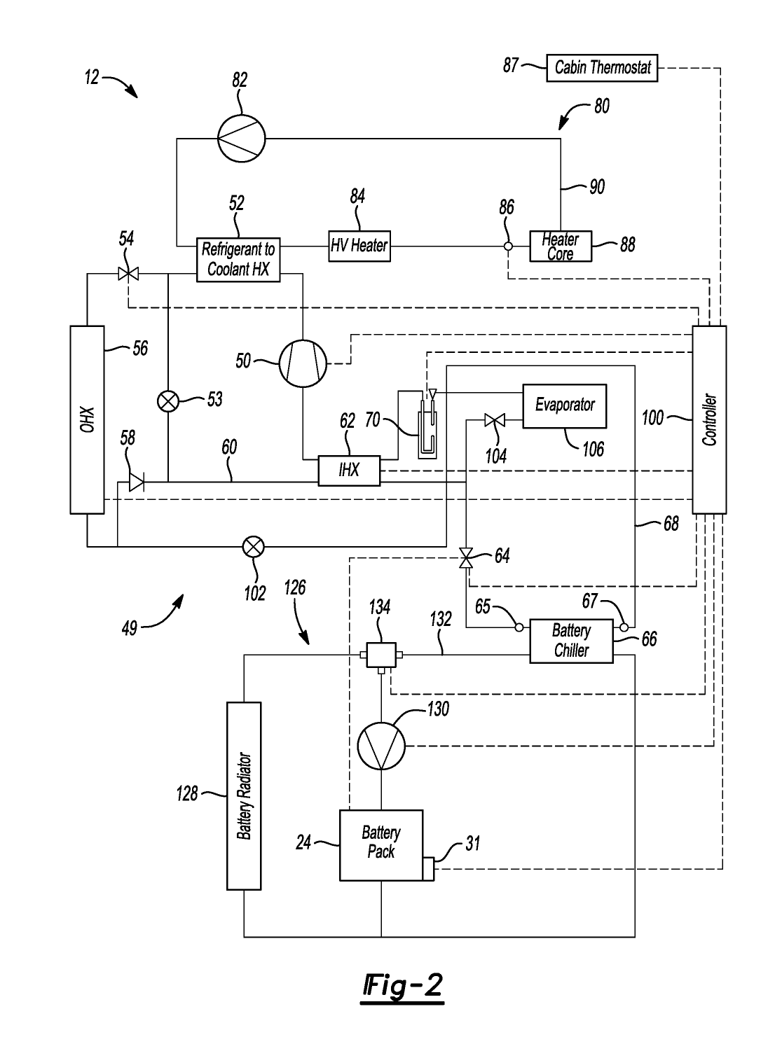

Referring to FIG. 2, a schematic of the vehicle climate control subsystems is illustrated. The description of how fluid flows through the subsystems for series evaporation mode and the parallel evaporation mode will be described in greater detail below. Portions of the various thermal-management systems may be located within various areas of the vehicle, such as the engine compartment, the cabin, and etc.

The vehicle 12 includes a heater core loop 80, a refrigerant loop 49 and a battery loop 126. The refrigerant loop 49 includes a compressor 50 connected to a refrigerant-to-coolant heat exchanger 52. Refrigerant is compressed by the compressor 50 and then condensed by the refrigerant to coolant heat exchanger. The refrigerant-to-coolant heat exchanger 52 may be a condenser, a device used to condense the fluid from its gaseous state to its liquid state by cooling it. The refrigerant-to-coolant heat exchanger 52 is a component within the heater core loop 80 as well as the refrigerant loop 49. Conduit 90 fluidly connects the refrigerant-to-coolant heat exchanger 52 to a heater core pump 82, a heater core 88, a heater core temperature sensor 86 and a high voltage heater 84.

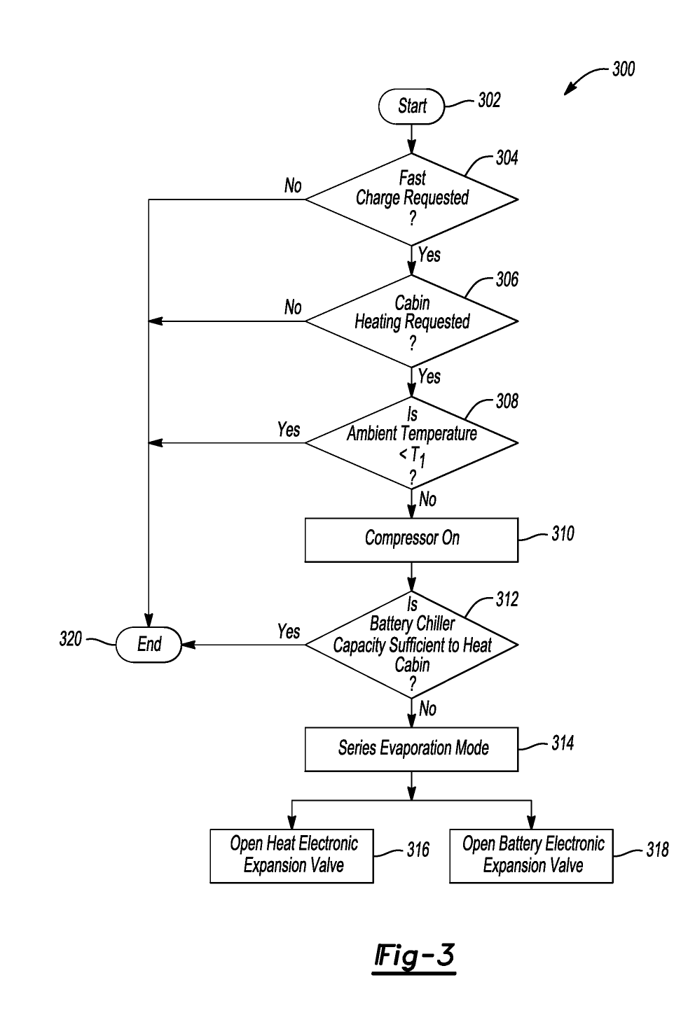

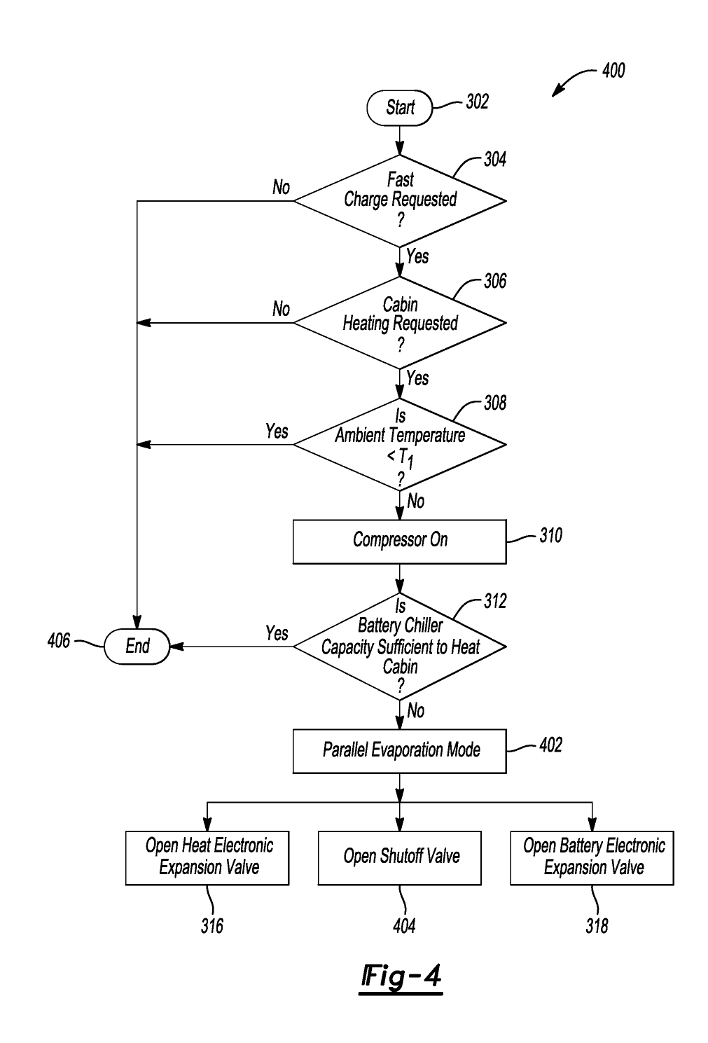

A heating electronic expansion valve (HEXV) 54 receives fluid from the refrigerant-to-coolant heat exchanger 52. The heating electronic expansion valve may be referred to as an ambient valve. The valve 54 is operable to be opened, closed, or continuously variable between the open and closed positions. The valve 54 is in a partially open position when the system is in either parallel or series evaporation mode. When open, valve 54 facilitates fluid flow through the outside heat exchanger 56. The outside heat exchanger may be a conventional radiator (sometimes referred to as a condenser in hotter temperatures) typically found in automobiles. As the fluid flows through the outside heat exchanger 56, heat is collected by the fluid. A check valve 58 is arranged near the outside heat exchanger and opens in response to a sufficient amount of pressure. When open, the check valve allows the fluid to flow through an internal heat exchanger 62. From the internal heat exchanger 62, the fluid flows to a battery electronic expansion valve (BEXV) 64. Both the HEXV and the BEXV are connected to the battery 24 and controller 100. The BEXV is operable to be opened, closed or continuously variable between the open and closed positions, in response to a signal from the controller 100. The controller 100 includes a program or algorithm to dictate whether to open or close the valves mentioned above (FIGS. 3-4).

When open, the BEXV facilitates fluid flow through the battery chiller 66. The battery chiller 66 is a part of the battery loop 126. The battery loop 126 includes a battery 24 or connected to a conduit 132. The conduit 132 is connected to an inlet and outlet of the battery chiller 66. As the fluid moves out of the battery chiller 66, the fluid flows through a three-way valve 134. The three-way valve is connected to a battery radiator 128, as well as a battery pump 130. The battery pump 130 facilitates the flow of fluid within the battery-battery loop 126. As the fluid passes through the battery chiller 66, the fluid collects heat generated from the battery 24. Once through the battery chiller 66, the fluid flows to an accumulator 70. The accumulator functions as a vapor-liquid separation and liquid storage device to prevent liquid from entering the compressor 50.

FIG. 3 is a flowchart 300 of an algorithm for controlling the vehicle climate control system (FIG. 2) in series evaporation mode. At operation 304 the controller determines whether a fast charge is requested. A fast charge may be defined as a charge having a relatively high voltage (e.g., 400-500V) and high current (e.g., 100-300 A) to charge battery 24.

At step 306, the controller determines whether cabin heating has been requested. A thermostat 87 (FIG. 2) may be disposed within the vehicle cabin and electrically connected to the controller 100. The thermostat facilitates a relatively constant temperature within the vehicle cabin. If the thermostat and the controller determine heating is required, the controller 100 then determines whether the ambient temperature is below T₁ at step 308. If the temperature is not below Ti, the compressor 50 is powered at step 310. Powering the compressor circulates fluid through the refrigerant loop 49.

At step 312, the controller determines whether the battery chiller 66 has sufficient capacity to heat the vehicle cabin. The chiller capacity is the amount of thermal energy passing between the refrigerant loop 49 and the battery loop 126. If the battery chiller capacity is not sufficient to heat the cabin, the controller places the vehicle in a series evaporation mode 314.

The chiller capacity may be calculated a number of different ways. One such way is by calculation using equation 1: Q=m·Cₚ(|Tᵢₙ−Tₒᵤₜ|), where m is the flow rate of the coolant, Cₚ is the specific heat, Tₒᵤₜ is the temperature of the coolant exiting the chiller, and Tᵢₙ is the temperature of the coolant entering the chiller. Tₒᵤₜ is determined by measuring the temperature of the fluid with temperature sensor 67. Tip is determined by measuring the temperature of the fluid with temperature sensor 65.

Another way to determine the chiller capacity is to measure the temperature of the fluid within the heater core loop. The fluid temperature is determined by heater core temperature sensor 86. The value determined may be compared with a threshold value by the controller 100. The two methods mentioned above are examples only. Other methods may be suitable such as using look up tables for a given charge rate, ambient temperature, or demanded cabin heat.

At step 314, the controller places the system in series evaporation mode. In series evaporation mode the shutoff valves 53 and 102, are closed. Additionally, the HEXV 54 and BEXV 64 are opened in step 316 and 318, respectively. Opening these valves facilitates the flow of fluid through the outside heat exchanger 56 and the battery chiller 66. Referring back to FIG. 2, when in the series evaporation mode, fluid flows through the HEXV 54 and collects heat from the outside heat exchanger 56. Because the shutoff valves 53 and 102 are closed, sufficient pressure opens the check valve 58. Once the check valve 58 is opened, the fluid flows from the outside-heat exchanger 56 to the battery chiller 66.

Referring to FIG. 4, a flowchart 400 for another algorithm for controlling the vehicle climate control system (FIG. 2) in parallel evaporation mode is shown. Steps 302 through steps 312 are identical to the steps in FIG. 3 as described above.

At step 402, the controller places the system in parallel evaporation mode. In parallel evaporation mode the shut off valves 53 and 102, are opened at step 404, if either of the shutoff valves were closed before entering the parallel evaporation mode. Opening the shutoff valves 53 and 102 facilitates two flows of fluid allowing the fluid to absorb heat through the outside-heat exchanger 56 and the battery chiller 66. This allows for the fluid to simultaneously absorb heat from the outside-heat-exchanger 56 and the battery chiller 66. Because of parallel flow through the heat exchangers, utilizing the parallel evaporation mode allows for greater system efficiency.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A thermal management system of a vehicle comprising:
a battery loop including a chiller defining a thermal capacity and an electronic expansion valve (BEXV) arranged to selectively route fluid to the chiller;
a heater-core loop including an outside heat exchanger and a heating expansion valve (HEVX) arranged to selectively route fluid to the outside heat exchanger; and
a controller configured to, in response to a battery charge rate exceeding a threshold, open the BEXV, and in response to the chiller having an insufficient capacity to achieve a temperature threshold as defined by a heater core thermometer, open the HEVX.

2. The system of claim 1, wherein in a series evaporation mode, the controller is further configured to close a first shutoff valve disposed between a refrigerant-to-coolant heat exchanger and an internal heat exchanger and a second shutoff valve disposed between the outside heat exchanger and an accumulator, so that the fluid collects heat from air surrounding the outside heat exchanger before the fluid collects heat from the chiller.

3. The system of claim 2, wherein a check valve is opened in response to a sufficient pressure build up in response to closing the first and second shutoff valves.

4. The system of claim 1, wherein in a parallel evaporation mode, the controller is further configured to open a first shutoff valve disposed between a refrigerant-to-coolant heat exchanger and an internal heat exchanger and a second shutoff valve disposed between the outside heat exchanger and an accumulator, so that the fluid simultaneously collects heat from air surrounding the outside heat exchanger and from the chiller before the fluid reaches the accumulator.

5. The system of claim 1, wherein opening the HEVX facilitates a flow of fluid through the heat exchanger so that the fluid absorbs heat from air located outside of the vehicle.

6. The system of claim 1, wherein the controller is further configured to, in response to receiving a heater core temperature measured by the heater core thermometer, compare the heater core temperature with a temperature differential of the chiller.

7. The system of claim 1, wherein the controller is further configured to, in response to receiving a signal indicating an ambient temperature, compare the ambient temperature with a value within a look-up table indicating an insufficient capacity of the chiller.

8. The system of claim 1 further comprising shutters defining a plurality of vanes disposed adjacent the outside heat exchanger, wherein the vanes are configured to move from an open position, to facilitate a flow of air to the outside heat exchanger, to a closed position.

9. A vehicle system comprising:
an ambient valve arranged to route fluid to an ambient heat exchanger;
a battery valve arranged to route fluid to a battery; and
a controller configured to, responsive to a charge rate exceeding a threshold, open the battery valve, and responsive to a chiller in fluid communication with the heat exchanger and battery having a heat rate indicative of an insufficient capacity to heat a vehicle cabin, open the ambient valve.

10. The system of claim 9, wherein in a series evaporation mode, the controller is further configured to close a first shutoff valve disposed between a refrigerant-to-coolant heat exchanger and an internal heat exchanger and a second shutoff valve disposed between the outside heat exchanger and an accumulator, so that the fluid collects heat from air surrounding the outside heat exchanger before the fluid collects heat from the chiller and before the fluid reaches the accumulator.

11. The system of claim 10, wherein a check valve is opened in response to closing the second shutoff valves.

12. The system of claim 11, wherein in a parallel evaporation mode, the controller is further configured to open the first shutoff valve disposed between a refrigerant-to-coolant heat exchanger and an internal heat exchanger and a second shutoff valve disposed between the outside heat exchanger and an accumulator, so that the fluid collects heat from air surrounding the outside heat exchanger and from the chiller before the fluid reaches the accumulator.

13. The vehicle system of claim 9, wherein the temperature differential is defined by a measured temperature from a heater core temperature sensor and a threshold temperature.

14. The vehicle system of claim 9, wherein the controller is further configured to, in response to the chiller having a temperature differential indicative of an insufficient capacity to heat the vehicle cabin, open the battery valve.

15. The vehicle system of claim 9 further comprising shutters defining a plurality of vanes disposed adjacent the ambient heat exchanger, wherein the vanes are configured to move from an open position, to facilitate a flow of air to the outside heat exchanger, to a closed position.

16. The vehicle system of claim 9, wherein the temperature differential is defined by a first temperature measured by an inlet thermometer arranged near an inlet of the chiller and a second temperature measured by an outlet thermometer arranged near an outlet of the chiller.

17. The vehicle system of claim 9, wherein the controller is further configured to, in response to receiving a signal indicating a battery temperature, compare the battery temperature with a value within a look-up table indicating an insufficient capacity of the chiller.

18. A method of controlling a vehicle climate system comprising:
opening an electronic expansion valve associated with a battery chiller in response to receiving requests for battery fast charge and cabin heating; and
opening an expansion valve associated with an outside heat exchanger to heat a vehicle cabin in response to a capacity of the chiller being insufficient to achieve a temperature threshold as defined by a heater core temperature sensor.

19. The method of claim 18, further comprising closing a first shutoff valve disposed between a refrigerant-to-coolant heat exchanger and an internal heat exchanger and a second shutoff valve disposed between the outside heat exchanger and an accumulator so that fluid collects heat from air surrounding the outside heat exchanger before the fluid collects heat from the battery chiller and before the fluid reaches the accumulator.

20. The method of claim 18, further comprising opening a first shutoff valve disposed between a refrigerant-to-coolant heat exchanger and an internal heat exchanger and a second shutoff valve disposed between the outside heat exchanger and an accumulator so that fluid collects heat from air surrounding the outside heat exchanger and from the battery chiller before the fluid reaches the accumulator.
